(19) United States
(12) Patent Application Publication
(10) Pub. No.: US 2017/0351155 A1
(43) Pub. Date: Dec. 7, 2017

(54) MIXTURES OF ENCAPSULATED ELECTRO-OPTIC MEDIUM AND BINDER WITH LOW SOLVENT CONTENT

(71) Applicant: E Ink Corporation, Billerica, MA (US)

(72) Inventors: Richard J. PAOLINI, JR., Framingham, MA (US); Jay William ANSETH, Canton, MA (US); Lynne A. MCCULLOUGH, Medford, MA (US); Erin Criswell CHANG, Bedford, MA (US)

(21) Appl. No.: 15/611,957

(22) Filed: Jun. 2, 2017

Related U.S. Application Data
(60) Provisional application No. 62/344,892, filed on Jun. 2, 2016.

(51) Int. Cl. G02F 1/167; G02F 1/155; G02F 1/1334; G02F 1/00; C08J 7/18; G02F 1/1335; G09G 3/34; G02B 1/10

(52) U.S. Cl. CPC G02F 1/167; G09G 3/344; G02F 1/155; G02B 1/10; G02F 1/0063; C08J 7/18; G02F 1/1335; G02F 1/1334; G02F 2001/1676; G02F 2001/1678; G02F 2202/28

(57) ABSTRACT

An electro-optic device includes a first substrate having a first conductive layer thereon; a second substrate having a second conductive layer thereon; and an electro-optic layer comprising electro-optic microcapsules in a 100% solids or substantially solvent free radiation curable binder, the electro-optic layer being disposed between the first and second substrates in contact with the first and second conductive layers.

### REFERENCE TO RELATED APPLICATIONS

This application claims priority to U.S. Provisional Application No. 62/344,892, filed Jun. 2, 2016, the entire content of which is herein incorporated by reference.

### TECHNICAL FIELD

This disclosure relates to electro-optic devices and methods and, more particularly, to electrophoretic devices wherein electrophoretic microcapsules are incorporated in a 100% solids or substantially solvent free radiation curable binder, and to methods for making such devices.

### BACKGROUND

Electrophoretic displays (such as an eReader) are typically opaque and operate in a reflective mode. This functionality is illustrated in FIG. 1A, where the reflectivity of light striking a surface is modulated by moving black or white charged particles toward a viewing surface with a suitable voltage. However, electrophoretic devices can also be made to operate in a so-called “shutter mode,” illustrated in FIG. 1B, wherein one operating state is substantially opaque and another operating state is light transmissive. When this “shutter mode” electrophoretic device is constructed on a transparent substrate, it is possible to regulate transmission of light through the device. One potential market for shutter mode electrophoretic media is windows with variable light transmission. As the energy performance of buildings and vehicles becomes increasingly important, electrophoretic media can be used as coatings on windows to enable the proportion of incident radiation transmitted through the windows to be electronically controlled by varying the optic state of the electrophoretic media.

For architectural applications, such as window or roofs, consumers want low cost and backward compatibility. That is, building owners are far more likely to incorporate energy-saving materials when they don't require a substantial retrofit of existing structures. Many current offering for “smart windows” require replacement of the entire window, which is both capital-intensive and time-consuming In addition to the expense, the energy consumption for some variable transmission windows is non-negligible due to the high voltages (excess of 100 volts) and requirement that the voltage be sustained while the window is in the open state.

Light modulators represent a potentially important market for electro-optic media. As the energy performance of buildings and vehicles becomes increasingly important, electro-optic media can be used as coatings on windows (including skylights and sunroofs) to enable the proportion of incident radiation transmitted through the windows to be electronically controlled by varying the optical state of the electro-optic media. Effective implementation of such “variable-transmissivity” (“VT”) technology in buildings is expected to provide (1) reduction of unwanted heating effects during hot weather, thus reducing the amount of energy needed for cooling, the size of air conditioning plants, and peak electricity demand; (2) increased use of natural daylight, thus reducing energy used for lighting and peak electricity demand; and (3) increased occupant comfort by increasing both thermal and visual comfort. Even greater benefits would be expected to accrue in an automobile, where the ratio of glazed surface to enclosed volume is significantly larger than in a typical building. Specifically, effective implementation of VT technology in automobiles is expected to provide not only the aforementioned benefits but also (1) increased motoring safety, (2) reduced glare, (3) enhanced mirror performance (by using an electro-optic coating on the mirror), and (4) increased ability to use heads-up displays. Other potential applications of VT technology include privacy glass and glare-guards in electronic devices.

### SUMMARY

The invention provides mixtures of encapsulated electrophoretic media in a (nearly) solvent-free binder. These mixtures can be spread as a coating over an optionally transparent electrode and then top-coated, sealed, and cured to make an electro-optic display or a variable transmission device. Because the mixture and electrodes can be applied to existing structures, it is possible to transform regular windows into variable transmission windows with low costs. The mixtures also lend themselves to simpler and less-expensive manufacturing of electro-optic displays that are thinner than state of the art devices. The thinner devices can change their optical states quicker and with lower voltages.

This disclosure describes mixtures of capsules containing electrophoretic materials that are distributed in a nearly solvent-free binder. In some instances the capsule walls and the binder materials are index matched to reduce the perceptible haze. The mixtures of the invention may be the basis for electro-optic devices. According to a first aspect, a flowable mixture is disclosed. The flowable mixture includes an encapsulated electrophoretic medium including an internal phase comprising a hydrocarbon liquid and suspended pigment particles and a polymeric binder comprising less than 5% (by weight) of solvent, wherein the viscosity of the flowable mixture is between 500 Centipoise and 10,000 Centipoise. Often the electrophoretic medium is encapsulated in a capsule having walls comprising collagen. Typically, the average capsule diameter is less than 50 micrometers. In some embodiments, the encapsulated electrophoretic medium is freeze dried. Typically, the polymeric binder comprises less than 1% (by weight) of solvent. In some embodiments, the mixture is 100% solids. In some embodiments, the polymeric binder comprises an acrylate or a polyurethane. In some embodiments, the polymeric binder is radiation-curable and/or includes cross-linkers. In some embodiments, a refractive index of the polymeric binder matches a refractive index of capsule walls encapsulating the electrophoretic medium. The refractive index of the polymeric binder may be between 1.50 and 1.60 at 550 nm.

Furthermore, the flowable mixture can be used to create an electro-optic device including a first substrate having a first conductive layer thereon, a second substrate having a second conductive layer thereon, and the flowable mixture described above, wherein the flowable mixture is interposed between the first conductive layer and the second conductive layer. In some embodiments, the first substrate and the first conductive layer are transparent or the second substrate and the second conductive layer are transparent. In other embodiments both the first and second substrates and the first and second conductive layers are transparent. In some embodiments, conductive layer(s) include indium tin oxide, however other conductive materials such as PEDOT are suitable for use with the invention. In some embodiments, the first or second conductive layer include a contact region for making electrical connections to driving electronics. In most instances such electro-optic devices do not include an adhesive layer interposed between the first conductive layer and the flowable mixture, or between the second conductive layer and the flowable mixture.

In a second aspect, a method for making an electro-optic device is disclosed. The method includes coating a first substrate having a first conductive layer thereon with a flowable mixture comprising an encapsulated electrophoretic medium including an internal phase comprising a hydrocarbon liquid and suspended pigment particles and a polymeric binder comprising less than 5% (by weight) of solvent, wherein the viscosity of the flowable mixture is between 500 Centipoise and 10,000 Centipoise, thereby creating a stack. A second conductive layer is then applied to the stack, wherein no adhesive layer is interposed between the first conductive layer and the flowable mixture or between the second conductive layer and the flowable mixture. In some embodiments, the polymeric binder of the mixture is radiation-curable and the method further comprises curing the polymeric binder. In other embodiments the method includes forming a contact region on the first or the second conductive layer. In another aspect the method includes masking an area of the first substrate before coating the first conductive layer with the flowable mixture.

### BRIEF DESCRIPTION OF DRAWINGS

Various aspects and embodiments of the application will be described with reference to the following figures. It should be appreciated that the figures are not necessarily drawn to scale. Items appearing in multiple figures are indicated by the same reference number in all the figures in which they appear.

FIG. 1A illustrates a two particle electrophoretic display that changes state by moving particles toward the viewer.

FIG. 1B illustrates a single particle electrophoretic display that meters the amount of light that travels through a substrate.

FIG. 2 is a cross-sectional diagram of an electro-optic device in accordance with embodiments. The electrophoretic particles are not shown but are understood to be present within capsules. The electro-optic device of FIG. 2 may include one or more sets of particles and be driven in a variety of ways including those shown in FIGS. 1A and 1B.

FIG. 3A shows a side view of a substrate including a conductive layer and a mask prior to coating with a mixture of the invention.

FIG. 3B shows a top view of a substrate including a conductive layer and a mask prior to coating with a mixture of the invention.

FIG. 4 shows a side view of a substrate including a conductive layer and a mask after coating with a mixture of the invention.

FIG. 5 shows a side view of a substrate including a conductive layer after coating with a mixture of the invention, and removing the mask.

FIG. 6 illustrates placement of a second glass substrate and a second conductive layer atop the mixture of the invention after having coated the mixture on a first glass substrate and first conductive layer.

FIG. 7 illustrates an embodiment in which the first and second glass substrates are replaced with a flexible transparent substrate.

FIG. 8 illustrates a method for making an electro-optic device using a mixture of the invention.

FIG. 9 illustrates the resulting device of FIG. 8 after the edges have been sealed.

FIG. 10 is a cross-sectional diagram of an electro-optic device in accordance with additional embodiments.

### DETAILED DESCRIPTION

The inventors have recognized that conventional processes for fabricating electrophoretic display devices use an aqueous slurry of electrophoretic capsules and require a drying operation to form a capsule film, followed by lamination of an adhesive over the capsule film. Such processes are relatively expensive and result in a device which requires a relatively high operating voltage. A high operating voltage may be unacceptable or undesirable in window devices and other electro-optic devices. The inventors have further recognized that a lower operating voltage and a simpler, lower cost process can be achieved by avoiding the need for a drying operation during the fabrication of the electro-optic device. A drying operation may not be practical in electro-optic devices where an electrophoretic layer is disposed between two substrates and may result in shrinkage of the electrophoretic layer. According to the disclosed technology, an electrophoretic layer includes electrophoretic microcapsules dispersed in a 100% solids or substantially solvent free radiation curable binder. As used herein, 100% solids denotes that 100% of the mixture remains after coating. That is, there is very little to no evaporation of a solvent after the mixture has been coated. In other words, for a 100% solids mixture, the coat weight and the final weight of the mixture of the mixture are substantially identical. An additional benefit of 100% solids mixture is that there are no volatile organic compounds (VOCs), which are known to create occupational safety hazards.

Conventional methods for fabrication of electrophoretic displays incorporate at least one lamination adhesive layer between the electrophoretic layer and one of the electrodes. The presence of a lamination adhesive layer together with the electrophoretic layer between the electrodes necessarily reduces the electric field acting on the electrophoretic layer at any given voltage between the electrodes, since some voltage drop necessarily occurs in the lamination adhesive layer. Although it is possible to compensate for the voltage drop across the lamination adhesive layer by increasing the operating voltage of the display, increasing the voltage across the electrodes is undesirable, since it increases the power consumption of the display, and may require the use of more complex and expensive control circuitry to handle the increased voltage. In addition, increased voltage may raise safety concerns.

This disclosure relates to electro-optic devices. In some embodiments, the disclosure relates to light modulators, such as variable transmission windows, mirrors and similar devices which modulate the amount of light or other electromagnetic radiation passing there through. For convenience, the term “light” is normally used herein, but this term should be understood to include electromagnetic radiation at non-visible wavelengths. For example, the disclosed technology may be applied to provide windows which can modulate infrared radiation for controlling temperatures within buildings. More specifically, the disclosed technology relates to electro-optic devices which use electrophoretic media.

The term “electro-optic”, as applied to a material or a display, is used herein in its conventional meaning in the imaging art to refer to a material having first and second display states differing in at least one optical property, the material being changed from its first to its second display state by application of an electric field to the material. Although the optical property is typically color perceptible to the human eye, it may be another optical property, such as optical transmission, reflectance, luminescence or, in the case of displays intended for machine reading, pseudo-color in the sense of a change in reflectance of electromagnetic wavelengths outside the visible range.

The term “gray state” is used herein in its conventional meaning in the imaging art to refer to a state intermediate two extreme optical states of a pixel, and does not necessarily imply a black-white transition between these two extreme states. For example, several of the E Ink patents and published applications referred to below describe electrophoretic displays in which the extreme states are white and deep blue, so that an intermediate “gray state” would actually be pale blue. Indeed, as already mentioned, the change in optical state may not be a color change at all. The terms “black” and “white” may be used hereinafter to refer to the two extreme optical states of a display, and should be understood as normally including extreme optical states which are not strictly black and white, for example the aforementioned white and dark blue states. The term “monochrome” may be used hereinafter to denote a drive scheme which only drives pixels to their two extreme optical states with no intervening gray states.

Some electro-optic materials are solid in the sense that the materials have solid external surfaces, although the materials may, and often do, have internal liquid- or gas-filled spaces. Such displays using solid electro-optic materials may hereinafter for convenience be referred to as “solid electro-optic displays”. Thus, the term “solid electro-optic displays” includes rotating bichromal member displays, encapsulated electrophoretic displays, microcell electrophoretic displays and encapsulated liquid crystal displays.

The terms “bistable” and “bistability” are used herein in their conventional meaning in the art to refer to displays comprising display elements having first and second display states differing in at least one optical property, and such that after any given element has been driven, by means of an addressing pulse of finite duration, to assume either its first or second display state, after the addressing pulse has terminated, that state will persist for at least several times, for example at least four times, the minimum duration of the addressing pulse required to change the state of the display element. It is shown in U.S. Pat. No. 7,170,670 that some particle-based electrophoretic displays capable of gray scale are stable not only in their extreme black and white states but also in their intermediate gray states, and the same is true of some other types of electro-optic displays. This type of display is properly called “multi-stable” rather than bistable, although for convenience the term “bistable” may be used herein to cover both bistable and multi-stable displays.

Another type of electro-optic display uses an electrochromic medium, for example an electrochromic medium in the form of a nanochromic film comprising an electrode formed at least in part from a semi-conducting metal oxide and a plurality of dye molecules capable of reversible color change attached to the electrode; see, for example O'Regan, B., et al., Nature 1991, 353, 737; and Wood, D., Information Display, 18(3), 24 (March 2002). See also Bach, U., et al., Adv. Mater., 2002, 14(11), 845. Nanochromic films of this type are also described, for example, in U.S. Pat. Nos. 6,301,038; 6,870,657; and 6,950,220. This type of medium is also typically bistable.

Another type of electro-optic display is an electro-wetting display developed by Philips and described in Hayes, R. A., et al., “Video-Speed Electronic Paper Based on Electrowetting”, Nature, 425, 383-385 (2003). It is shown in U.S. Pat. No. 7,420,549 that such electro-wetting displays can be made bistable.

One type of electro-optic display, which has been the subject of intense research and development for a number of years, is the particle-based electrophoretic display, in which a plurality of charged particles move through a fluid under the influence of an electric field. Electrophoretic displays can have attributes of good brightness and contrast, wide viewing angles, state bistability, and low power consumption when compared with liquid crystal displays. Nevertheless, problems with the long-term image quality of these displays have prevented their widespread usage. For example, particles that make up electrophoretic displays tend to settle, resulting in inadequate service-life for these displays.

As noted above, electrophoretic media require the presence of a fluid. In most prior art electrophoretic media, this fluid is a liquid, but electrophoretic media can be produced using gaseous fluids; see, for example, Kitamura, T., et al., “Electrical toner movement for electronic paper-like display”, IDW Japan, 2001, Paper HCS1-1, and Yamaguchi, Y., et al., “Toner display using insulative particles charged triboelectrically”, IDW Japan, 2001, Paper AMD4-4). See also U.S. Pat. Nos. 7,321,459 and 7,236,291. Such gas-based electrophoretic media appear to be susceptible to the same types of problems due to particle settling as liquid-based electrophoretic media, when the media are used in an orientation which permits such settling, for example in a sign where the medium is disposed in a vertical plane. Indeed, particle settling appears to be a more serious problem in gas-based electrophoretic media than in liquid-based ones, since the lower viscosity of gaseous suspending fluids as compared with liquid ones allows more rapid settling of the electrophoretic particles.

Numerous patents and applications assigned to or in the names of the Massachusetts Institute of Technology (MIT) and E Ink Corporation describe various technologies used in encapsulated electrophoretic and other electro-optic media. Such encapsulated media comprise numerous small capsules, each of which itself comprises an internal phase containing electrophoretically-mobile particles in a fluid medium, and a capsule wall surrounding the internal phase. In many instances, the capsules comprise a collagen matrix, for example a collagen acacia matrix, as described in the U.S. patents listed below. Typically, the capsules are themselves held within a polymeric binder to form a coherent layer positioned between two electrodes. The technologies described in these patents and applications include:
(a) Electrophoretic particles, fluids and fluid additives; see for example U.S. Pat. Nos. 7,002,728 and 7,679,814;
(b) Capsules, binders and encapsulation processes; see for example U.S. Pat. Nos. 5,930,026; 6,067,185; 6,130,774; 6,172,798; 6,249,271; 6,327,072; 6,392,785; 6,392,786; 6,459,418; 6,839,158; 6,866,760; 6,922,276; 6,958,848; 6,987,603; 7,061,663; 7,071,913; 7,079,305; 7,109,968; 7,110,164; 7,202,991; 7,242,513; 7,304,634; 7,339,715; 7,391,555; 7,411,719; 7,477,444; 7,561,324; 7,848,007; 7,910,175; 7,952,790; 8,035,886; 8,129,655; 8,446,664; and 9,005,494; and U.S. Patent Applications Publication Nos. 2005/0156340; 2007/0091417; 2008/0130092; 2009/0122389; and 2011/0286081;
(c) Films and sub-assemblies containing electro-optic materials; see for example U.S. Pat. Nos. 6,982,178 and 7,839,564;
(d) Backplanes, adhesive layers and other auxiliary layers and methods used in displays; see for example U.S. Pat. Nos. 7,116,318 and 7,535,624;
(e) Color formation and color adjustment; see for example U.S. Pat. Nos. 7,075,502 and 7,839,564;
(f) Methods for driving displays; see for example U.S. Pat. Nos. 7,012,600 and 7,453,445;
(g) Applications of displays; see for example U.S. Pat. Nos. 7,312,784 and 8,009,348; and
(h) Non-electrophoretic displays, as described in U.S. Pat. Nos. 6,241,921; 6,950,220; 7,420,549 8,319,759; and 8,994,705 and U.S. Patent Application Publication No. 2012/0293858.

Many of the aforementioned patents and applications recognize that the walls surrounding the discrete microcapsules in an encapsulated electrophoretic medium could be replaced by a continuous phase, thus producing a so-called polymer-dispersed electrophoretic display, in which the electrophoretic medium comprises a plurality of discrete droplets of an electrophoretic fluid and a continuous phase of a polymeric material, and that the discrete droplets of electrophoretic fluid within such a polymer-dispersed electrophoretic display may be regarded as capsules or microcapsules even though no discrete capsule membrane is associated with each individual droplet; see for example, the aforementioned U.S. Pat. No. 6,866,760. Accordingly, for purposes of the present application, such polymer-dispersed electrophoretic media are regarded as sub-species of encapsulated electrophoretic media.

A related type of electrophoretic display is a so-called “microcell electrophoretic display”. In a microcell electrophoretic display, the charged particles and the fluid are not encapsulated within microcapsules but instead are retained within a plurality of cavities formed within a carrier medium, typically a polymeric film. See, for example, U.S. Pat. Nos. 6,672,921 and 6,788,449, both assigned to Sipix Imaging, Inc.

Although electrophoretic media are often opaque (since, for example, in many electrophoretic media, the particles substantially block transmission of visible light through the display) and operate in a reflective mode, many electrophoretic displays can be made to operate in a so-called “shutter mode” in which one display state is substantially opaque and one is light-transmissive. See, for example, U.S. Pat. Nos. 5,872,552; 6,130,774; 6,144,361; 6,172,798; 6,271,823; 6,225,971; and 6,184,856. Dielectrophoretic displays, which are similar to electrophoretic displays but rely upon variations in electric field strength, can operate in a similar mode; see U.S. Pat. No. 4,418,346. Other types of electro-optic displays may also be capable of operating in shutter mode. Electro-optic media operating in shutter mode may be useful in multi-layer structures for full color displays; in such structures, at least one layer adjacent the viewing surface of the display operates in shutter mode to expose or conceal a second layer more distant from the viewing surface.

U.S. Pat. No. 7,327,511 describes various factors which are important in adapting electrophoretic media for optimum performance in light modulators. One important factor is minimization of haze. In this application, “haze” refers to the percentage of diffuse transmitted light (light that is scattered as it is transmitted), compared to total transmitted light. In order to create a variable transmission film (VTF) with reduced haze it is important to match the refractive index of all components present at non-planar interfaces. In capsule-based electrophoretic media such non-planar interfaces exist at the boundaries between the internal phase (the electrophoretic particles and the surrounding fluid) and the capsule walls, and at the boundaries between the capsules walls and the binder which, as described in the aforementioned E Ink and MIT patents and applications, normally surrounds the capsules and forms them into a coherent layer. In polymer-dispersed and some microcell electrophoretic media, such curved surfaces exist at the boundaries between the internal phase and the surrounding continuous phase or binder.

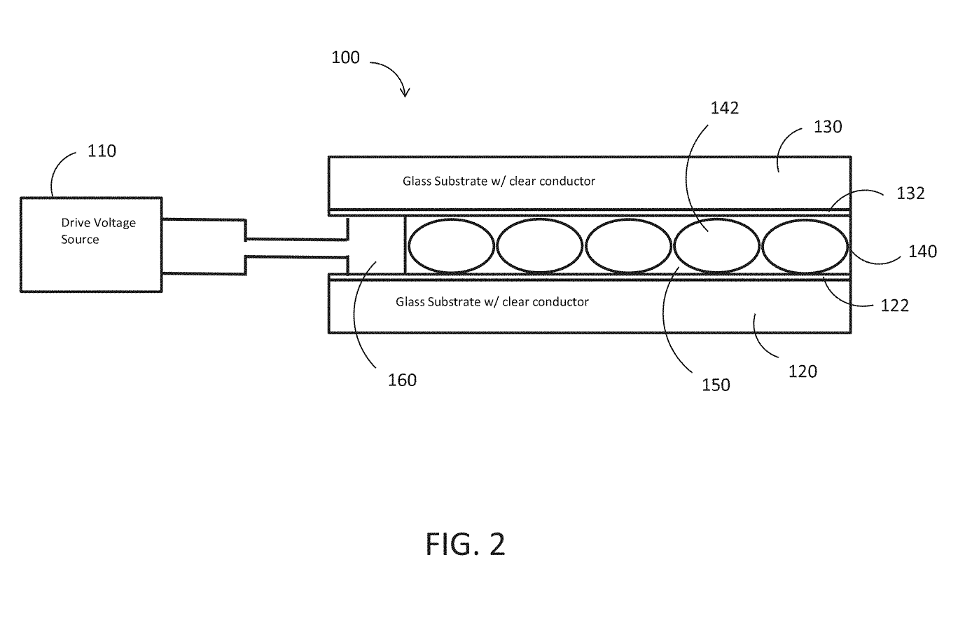

A cross-sectional view of an electro-optic device 100 in accordance with embodiments is shown in FIG. 2. The electro-optic device 100 is connected to a drive voltage source 110, which may include multiple independent drive voltage sources, or one electrode may be held at ground while the other electrode is driven with a drive voltage source. Electro-optic device 100 is configured as a window in which transmission of incident radiation is electronically controlled by the drive voltage source 110. The electro-optic device 100 incorporates an electrophoretic layer for controlling light transmission as discussed below.

As shown in FIG. 2, the electro-optic device 100 includes a first substrate 120 having a first conductive layer 122 formed thereon, a second substrate 130 having a second conductive layer 132 formed thereon and an electrophoretic layer 140 positioned between the first substrate 120 and the second substrate 130. The electrophoretic layer 140 is in direct contact with the first and second conductive layers 122 and 132, and includes electrophoretic microcapsules 142 in a radiation curable binder 150. The electro-optic device 100 of FIG. 2 does not include a lamination adhesive layer between the electrophoretic layer 140 and any of the conductive layers (122 and 132). In some embodiments, an adhesive may be used to bind the conductive layer (122 or 132) to the substrate (120 or 130).

The drive voltage source 110 is electrically connected to the first conductive layer 122 and/or to the second conductive layer 132 in a contact region 160 between first substrate 120 and second substrate 130 that is not filled with electrophoretic layer 140. In other embodiments, electronic circuitry, such as drive circuitry, may be mounted in contact region 160. In further embodiments, the contact region 160 may be omitted and other arrangements may be used for making electrical connections to first and second conductive layers 122 and 132. In some embodiments, the first conductive layer is held at ground while the drive circuitry delivers a voltage waveform to the second conductive layer.

In the electro-optic device 100 of FIG. 2, the electrophoretic layer 140 is relatively thin in order to achieve a low operating voltage. In particular, the electrophoretic layer 140 may be in a range of 10 microns to 200 microns in thickness, in some embodiments, the capsules are smaller than 50 microns, e.g., smaller than 40 microns, e.g., smaller than 30 microns, e.g., smaller than 20 microns. However, the electrophoretic layer 140 is not limited to this range of thicknesses. The first substrate 120 and second substrate 130 would not permit a drying operation if an aqueous capsule slurry was used. By using the 100% solids or substantially solvent free radiation curable binder 150, drying of the electrophoretic layer 140 is not required. Instead, one of the substrates is coated with a slurry of the electrophoretic microcapsules 142 and the 100% solids or substantially solvent free radiation curable binder 150, the second substrate 130 is pressed onto the stack, and the electrophoretic layer 140 is cured by application of suitable radiation through substrates 120 and 130.

The electrophoretic microcapsules 142 each include an internal phase containing electrophoretically-mobile particles suspended in a liquid suspending medium, and a capsule wall surrounding the internal phase. Alternatively, a polymer-dispersed electrophoretic display (PDEPID) version, where an encapsulated electrophoretic medium is replaced by a continuous phase, may be used. In some embodiments of the shutter mode, the microcapsules 142 may have two states. The drive voltage source 110 applies voltages to the electro-optic device 100 so as to produce a first state in which the electrophoretic layer 140 is substantially opaque and has a single color, and a second state in which the electrophoretic layer 140 is light transmissive. In the two state embodiments, the microcapsules 142 may include one or more particle types, each of the same electrical polarity. In the first state, particles in the microcapsules 142 are dispersed throughout the microcapsules and block light transmission. In the second state, the particles in the microcapsules 142 move to the side wall of each microcapsule and form a toroid of particles that lies substantially in a plane parallel to the plane of the electrophoretic layer 140. The center of the toroid is relatively free of particles and transmits light.

In further embodiments, the electrophoretic microcapsules 142 may have three states including a first state in which the electrophoretic layer 40 is substantially opaque white or a single color, a second state in which the electrophoretic layer 140 is substantially opaque black or a different color, and a third state in which the electrophoretic layer 140 is light transmissive. In these embodiments, the electrophoretic microcapsules 142 include two particle types of opposite electrical polarity.

In further embodiments, the electro-optic device 100 may have four states including a first state in which the electrophoretic layer 140 is substantially opaque white or a single color, a second state in which the electrophoretic layer 140 is substantially opaque black or a different color, a third state in which the electrophoretic layer 140 is light transmissive, and a fourth state in which the electrophoretic layer 140 is in a magnetic addressed writing state, for example, by a stylus. In these embodiments, the electrophoretic microcapsules 142 include two particle types of opposite electrical polarity, wherein one of the particle types is magnetic.

Compositions and structures of electrophoretic microcapsules and methods of making electrophoretic microcapsules are known and will not be described in detail herein. Shutter mode electrophoretic devices are described in U.S. Pat. No. 7,999,787, which is hereby incorporated by reference in its entirety. As described therein, shutter mode devices may use microcapsules with a single particle type or two particle types. In the light transmissive state, the particles may move to the side wall of the cavity enclosed by the capsule wall and/or may form strings perpendicular to the electrodes, thus allowing transmission of light through the capsules. In the opaque state, the particles are dispersed throughout the capsule and block transmission of light. The capsules may have a substantially prismatic shape wherein a width parallel to the planes of the electrodes is significantly greater than a height perpendicular to these planes. The prismatic shape reduces the proportion of the area of the capsule which is occupied by the particles in the light transmissive state. Operation in the shutter mode may involve electrophoretic forces, induced charge electro-osmotic (ICED) forces and dielectrophoretic forces, and/or a combination of these forces. Shutter mode electrophoretic devices are also described in U.S. Pat. No. 7,327,511 and U.S. Publication No. 2008/0136774. Microcapsule size may be as small as 10 microns and as large as 100 microns. Microcapsules are preferably between 20-50 microns in diameter. Larger microcapsule size (e.g., greater than 50 microns) may increase visible coating grain on the display; using fixed pattern arrays such as microcells may reduce the visible coating grain and improve electro-optic performance.

The electro-optic device 100 of FIG. 2 may be driven by an oscillatory waveform, such as a sinusoidal wave, a square wave, a triangular wave or another periodic waveform. The electro-optic device can be switched between light transmissive and opaque states by changing the frequency of the applied periodic drive voltage. Open state typically has a higher frequency as compared to the closed state. By way of example only, the device may be in an opaque state at frequencies lower than about 50 Hertz and may be in a light transmissive state at frequencies above about 50 Hertz. Intermediate states can be achieved by utilizing intermediate drive frequencies. Further details regarding drive voltages are described in the aforementioned U.S. Pat. No. 7,999,787.

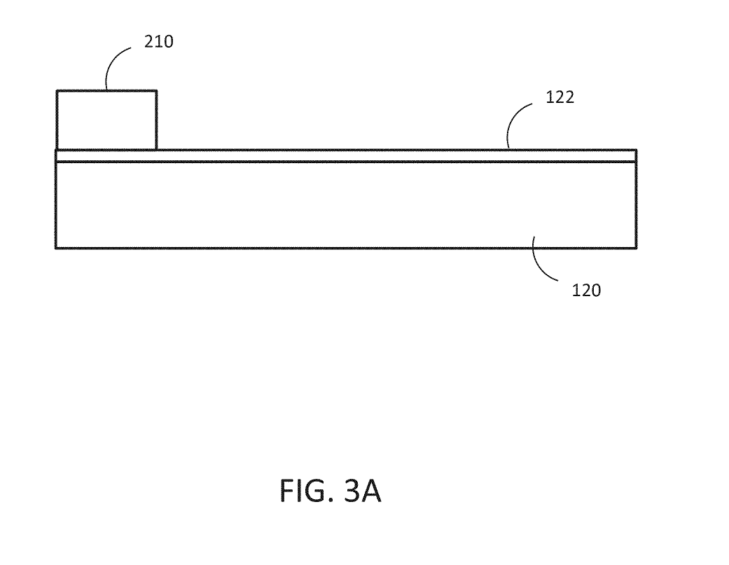

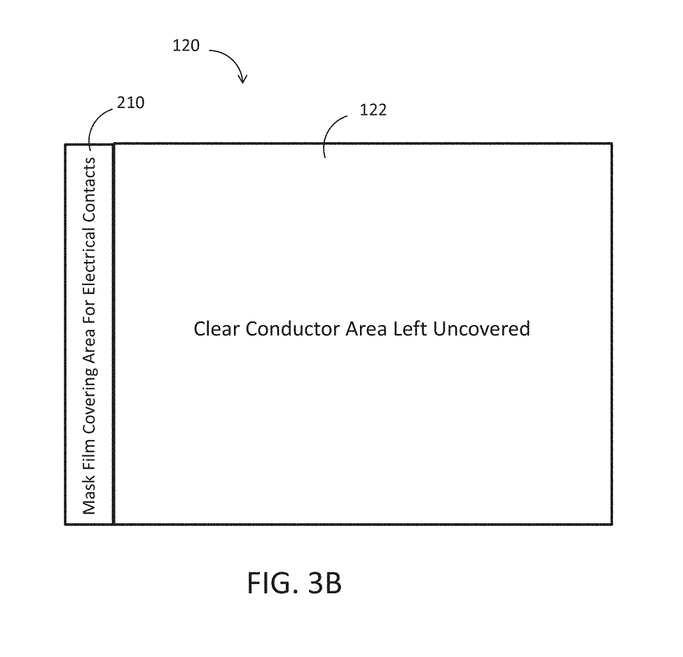

Embodiments of a process for making electro-optic device 100 are described with reference to FIGS. 3A-6. The process of FIGS. 3A-6 is described with reference to a glass substrate having a clear conductive layer. However, it will be understood that the process does not require glass substrates and does not require that both substrates and both conductive layers be transparent. The process may be used for producing an electro-optic device having an electrophoretic layer capable of low voltage operation. Further, the process may be used for producing electro-optic devices generally, without limitations on operating voltages and thicknesses. In particular, the process may be used for producing electrophoretic display devices, electrophoretic windows, and other electrophoretic devices. Additionally, it is understood that one or both conductive layers may be replaced with planar electrodes, such as interdigitated electrodes, or an active matrix comprising an array of electrodes that are individually addressable. The planar electrodes may be transparent, however, in many cases it is unnecessary because the device will only be viewed from above, i.e., for use as an eReader.

Referring to FIGS. 3A and 3B, first substrate 120 is provided with first conductive layer 122. In some embodiments, the first substrate may be glass and the first conductive layer 122 may be indium tin oxide (ITO). Other transparent conductive layers may be used, including but not limited to poly(3,4-ethylenedioxythiophene) (PEDOT), carbon nanotube (CNT), graphene, other transparent conductive oxides (CTO) such as fluorine doped tin oxide (FTO), and nanowire electro-materials. The substrate 120 with conductive layer 122 is partially covered with a masking film 210. In the embodiment of FIGS. 3A and 3B, the masking film 210 extends along the full length of one of the short sides of a rectangular substrate. However, other configurations of the masking film 210 may be used in different applications. For example, the masking film may be provided along more than one side of the substrate or may be provided along part of one or more sides of the substrate. Various materials can be used as the masking film 210. One suitable option is a layer of Kapton® tape (DuPont) which is preferably thinner than about 75 microns. Another suitable masking film is the RP301 mask, commercially available from Nitto Denko (Tokyo, Japan). In further embodiments, masking film 210 can be provided by use of known lithographic techniques. As shown in FIG. 3B, the remainder of substrate 120, except for the area covered by masking film 210, is left uncovered at this stage.

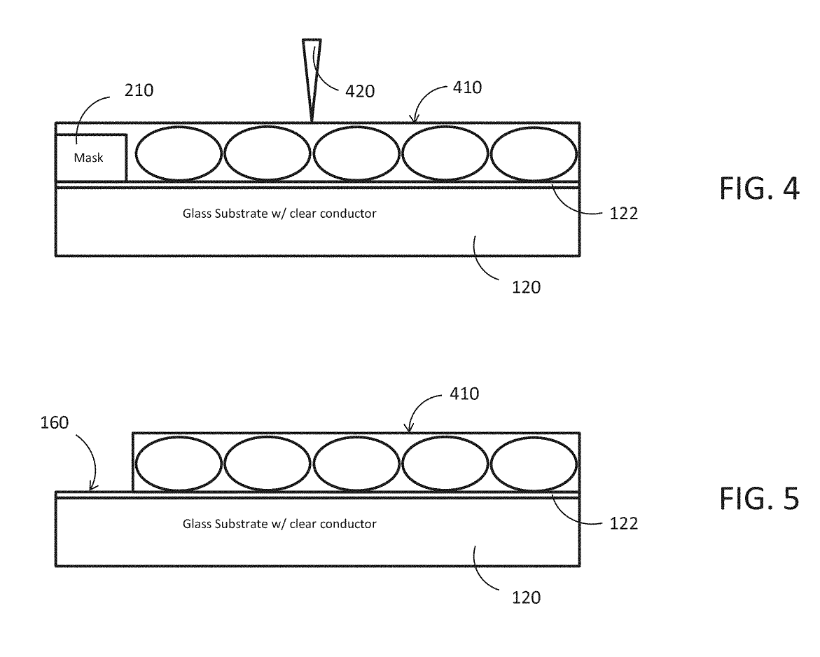

Referring now to FIG. 4, the substrate 120 with conductive layer 122 is coated, in areas not covered by masking film 210, with an electrophoretic ink slurry that becomes the electrophoretic layer 140. The preparation of the coating slurry involves the use of a dry powder of electrophoretic microcapsules.

The dry powder can be prepared by freeze drying or spray drying. Freeze drying is an effective technique to remove water from the microcapsules without substantially altering the basic structure of the microcapsule wall. The first step in the freeze drying process involves flash freezing of an aqueous microcapsule dispersion. Rapid freezing prevents formation of large ice crystals, which may damage the microcapsule walls. To remove all water from the flash frozen capsules, the pressure is reduced below 0.006 atmosphere (pressure at the triple point of water), which allows the sublimation of ice directly into water vapor when the temperature is increased. Spray drying is an alternate method for the drying of microcapsules to a powder. In spray drying an aqueous mixture of capsules is aerosolized and dispersed into a stream of hot dry air or dry nitrogen. The water is driven from the aerosolized particles, resulting in a powder for inclusion into a slurry of the invention. Suitable freeze drying and spray drying apparatus is available commercially from GEA Process Engineering (Columbia, Md.).

The microcapsule powder is then mixed with a 100% solids binder, preferably a radiation curable binder. The ratio of dried capsules to binder is typically between 20:1 and 5:1 (weight of capsules: weight of binder). In some embodiments the ratio of dried capsules to binder is between 18:1 and 12:1, e.g., between 16:1 and 14:1. In some embodiments the ratio is about 15:1. The resulting mixtures are flowable in that they will flow from a container onto a surface, however they are more viscous than water. For most applications, the mixture has a viscosity between 100 Centipoise and 100,000 Centipoise, for example, between 500 and 10,000 Centipoise. In some embodiments, the viscosity is between 2,000 and 8,000 Centipoise. In some embodiments, the refractive index of the binder material matches the refractive index of the capsule wall. As described in U.S. 2017/0022403, which is incorporated by reference in its entirety, the refractive index value varies based on the microcapsule composition, amount and kind of additives used, and the type of electro-optic display among other factors. The material used in the microcapsule wall may change the refractive index value. For example, gelatin or gelatin acacia microcapsules have a refractive index of between 1.52 and 1.55. Microcapsules having polyvinyl alcohol (PVOH) walls may decrease the refractive index to 1.51 or below, whereas urea-formaldehyde (UF) microcapsules may increase the refractive index to 1.56 or higher. Typically, the refractive index ranges from 1.50 to 1.60 but may be as high as 2. Further, the radiation curable binder is light transmissive after curing. In some embodiments, the radiation curable binder is a UV (ultraviolet) curable binder. In some embodiments, the radiation curable binder includes a cross-linker that is light activated.

Materials described in previously-referenced U.S. Patent Publication 2017/0022403 are examples of radiation curable binders that may be used in the present invention. For example, one suitable binder material is a blend of monomers, type 10408 available from Sartomer, with a refractive index of 1.522. Alternate high index monomers are available from Norland Optical Adhesives. Other blends of monomers available from Sartomer include acrylic monomers, which have constituent aromatic functionality to influence the refractive index. A non-limiting list includes: Sartomer SR9087—commercially-available alkoxylated phenol acrylate monomer; Sartomer SR339—commercially-available 2-phenoxyethyl acrylate monomer; Sartomer SR495B—commercially-available caprolactone acrylate monomer; Sartomer SR9038—commercially-available ethoxylated (30) bisphenol A diacrylate monomer; Sartomer 966H90—commercially-available aliphatic polyester based urethane diacrylate oligomer blended with 10% 2(2-ethoxyethoxy) ethyl acrylate; Sartomer SR349—commercially-available ethoxylated (3) bisphenol A diacrylate monomer; Sartomer SR9055—commercially-available acidic acrylate adhesion promoter; Sartomer SR531—commercially-available cyclic trimethylopropane formal acrylate (CTFA) monomer; Sartomer SR3108—commercially-available acrylate oligomer; Sartomer SR256—commercially-available acrylate oligomer; Sartomer CN9782—commercially-available aromatic urethane acrylate oligomer; and Sartomer CN131B—commercially-available low viscosity acrylic oligomer. A preferred blend of monomers includes 15 per hundred resin (phr) of Sartomer SR531, 26 phr of Sartomer SR9038 and 59 phr of Sartomer SR3108.

Further, the radiation curable binder is substantially solventless, that is, it does not include solvents beyond the monomer components and additives themselves. For example, the formulations do not include ketones, ethers, hexanes, or other low-chain length alkane solvents without polymerizable functionality, i.e., acrylates or epoxides. Such formulations do not require a drying step during processing and improve the reliability of layered electro-optic assemblies and other materials, i.e., variable transmission windows, because there is less evaporative shrinking during the cure, leading to more consistent films.

Once the slurry is mixed, the masked substrate 120 with conductive layer 122 is then coated with an electrophoretic ink slurry 410, using a bar coater 420 as shown in FIG. 4. Typically, the coating is around 20 grams of mixture per m². Thinner coatings, e.g., between 20 g/m² and 10 g/m² may be suitable for some applications. In some applications heavier coatings, e.g., between 50 g/m² and 20 g/m² may be suitable. Slot-die coating, bar coating, knife coating, and spin-coating methods, among others, are suitable methods to apply the ink slurry directly to the masked substrate. A resulting stack, including the electrophoretic ink slurry 410, first conductive layer 122 and first substrate 120, is shown in FIG. 4. Bar coating has been used successfully to coat a glass substrate having a clear conductive layer with the electrophoretic ink slurry 410. After coating the substrate with electrophoretic ink slurry 410, the masking film 210 can be removed, thereby exposing the first conductive layer 122 in the contact region 160. Removing the masking film 210 results in the structure shown in FIG. 5 in which the electrophoretic ink slurry 410 remained uncured, however the contact region 160 is not covered, and available to make an electrical connection.

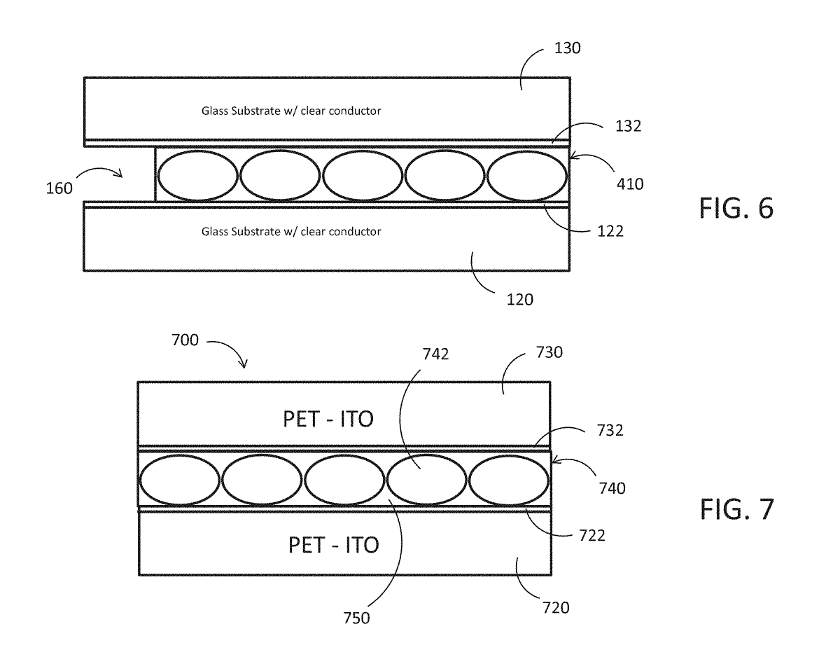

At this stage, the second substrate 130 with second conductive layer 132 is applied to the stack with light pressure, allowing the electrophoretic ink slurry 410 to coat the second conductive layer 132. If there are imperfections or bubbles in the electrophoretic ink slurry 410, an autoclave can be used to pull out any gas bubbles. After all of the bubbles are removed from the electrophoretic ink slurry, the 100% solids or substantially solvent free radiation curable binder 150 is cured. In the case of Sartomer 10408 radiation curable binder, is cured with ultraviolet radiation using a 300 W ‘D’ spectra lamp at a belt speed of 10-15 fps. This results in electro-optic shutter mode window as shown in FIG. 6.

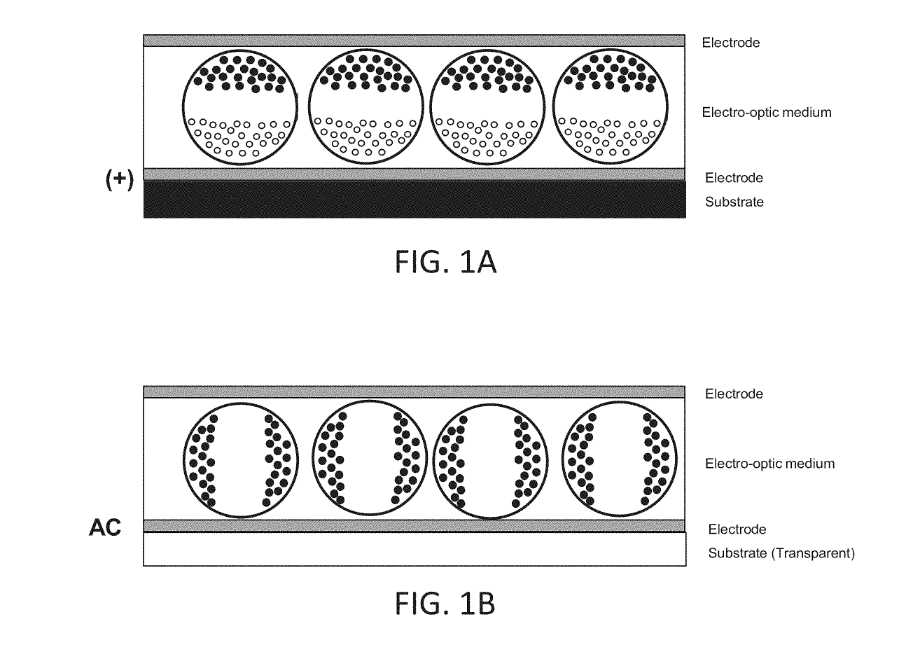

Additional embodiments are described with reference to FIGS. 7-9. The embodiments of FIGS. 7-9 use flexible substrates and conductive layers. Further, the embodiments of FIGS. 7-9 differ from the embodiments of FIGS. 1-6 by not requiring a contact region in order to make electrical connections to the conductive layers.

Referring to FIG. 7, an electro-optic device 700 includes a first substrate 720 having a first conductive layer 722 formed thereon, a second substrate 730 having a second conductive layer 732 formed thereon and an electrophoretic layer 740 positioned between the first substrate 720 and the second substrate 730. The electrophoretic layer 740 is in contact with the first and second conductive layers 722 and 732. The electrophoretic layer 740 includes electrophoretic microcapsules 742 in a 100% solids or substantially solvent free radiation curable binder 750.

The substrates 720 and 730 may be a plastic material, such as for example polyethylene terephthalate (PET), and the conductive layers 722 and 732 may be ITO. However, this is not a limitation, and other substrate materials and conductive layer materials may be used. For example, the substrates 720 and 730 can be different flexible light transmissive materials such as polystyrene, polycarbonate, or polyurethanes. The conductive layers may be made from conductive polymers such as PEDOTs, graphene, or dispersed conductive particles such as nanotubes, nanoparticles, or nanowires. The electrophoretic layer 740, including an electrophoretic microcapsules 742 and 100% solids or substantially solvent free radiation curable binder 750, may correspond to the electrophoretic layer 140 described above. As shown in FIG. 7, a contact region is not used. The connection of first conductive layer 722 and second conductive layer 732 to a drive voltage source (FIG. 2) is discussed below.

The electro-optic device 700 may be fabricated according to the process shown in FIGS. 2-6 and described above, with the exception that a masking film is not required to form a contact region. In particular, the first substrate 720 with first conductive layer 722 is coated, in the absence of second substrate 730, with an electro-optic ink slurry that becomes the electro-optic layer 740. The preparation of the coating slurry involves the use of a dry powder of electro-optic microcapsules and a 100% solids or substantially solvent free radiation curable binder, as described above. A resulting stack includes the electro-optic ink slurry, first conductive layer 722 and first substrate 720. At this stage, the second substrate 730 with second conductive layer 732 is applied to the stack with light pressure, allowing the liquid electro-optic ink slurry to coat the second conductive layer 732. After any bubbles are removed from the electro-optic ink slurry, the 100% solids or substantially solvent free radiation curable binder 750 is cured. This results in the electro-optic device 700 shown in FIG. 7.

Since the substrates 720 and 730 may be flexible, a continuing roll-to-roll process can be used to laminate a second substrate 730 and the second conductive layer 732 onto the uncured electro-optic ink slurry at room temperature. After leaving the roller, a curing station can cure the 100% solids or substantially solvent free radiation curable binder 750, creating the electro-optic device 700 of FIG. 7. The device can be rolled up and saved to be cut into windows of desired sizes.

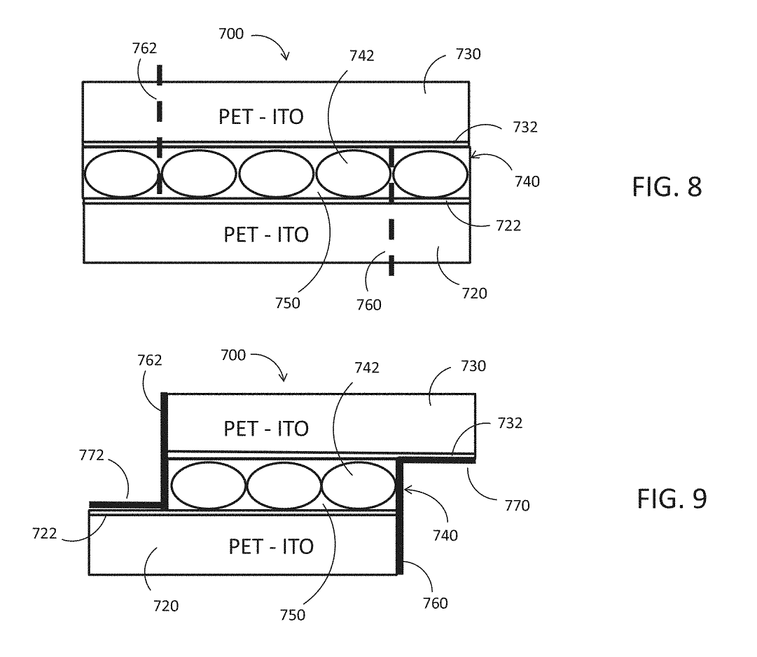

A process for making electrical contact to the first conductive layer 722 and the second conductive layer 732 is described with reference to FIGS. 8 and 9. Following curing of the radiation curable binder 750, the first substrate 720, the first conductive layer 722 and the electro-optic layer 740 are cut along a cut line 760 near an edge of the device, without cutting second substrate 730 or second conductive layer 732. A portion of the first substrate 720, first conductive layer 722 and electro-optic layer 740 defined by cut line 760 is removed, as shown in FIG. 9, thereby exposing a surface 770 of second conductive layer 732 for electrical contact. Similarly, the second substrate 730, the second conductive layer 732 and the electro-optic layer 740 are cut along a cut line 762 near another edge of device 700, without cutting first substrate 720 or first conductive layer 722. A portion of second substrate 730, second conductive layer 732 and electro-optic 740 defined by cut line 762 is removed, as shown in FIG. 9, thus exposing a surface 772 of first conductive layer 722 for electrical contact.

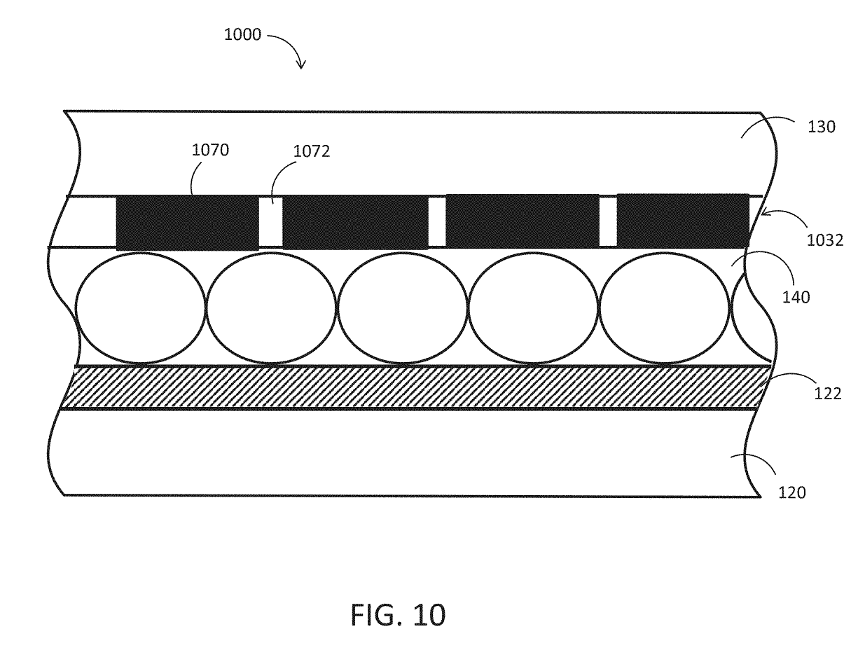

A cross-sectional view of an electro-optic device 1000 in accordance with additional embodiments is shown in FIG. 10. The electro-optic device 1000 is similar to the electro-optic device 100 shown in FIG. 2 and the electro-optic device 700 shown in FIG. 7, except that at least one of the conductive layers is patterned to provide conductive areas and open areas. Referring to FIG. 10, a conductive layer 1032 is formed as a pattern having addressable conductive areas 1070 and insulating areas 1072. The pattern of the conductive layer 1032 may be formed, for example, as a grid including rows and columns of conductive areas 1070. The conductive layer may include an active matrix of electrodes controlled with thin film transistors (“TFT backplane”). In other embodiments, the conductive layer 1032 may be formed as a pattern of parallel lines which may be interdigitated. In other embodiments the conductive layer 1032 is formed as a pattern of overlapping lines. In some embodiments, the grid may be rectangular, hex, or other shapes. The conductor lines may be as narrow as 10 microns or less. One of skill in the art will appreciate that a variety of architectures for the conductive layer 1032 are available.

In operation, when a voltage is applied between conductive layer 1032 and transparent conductive layer 122, the particles in the microcapsules of electrophoretic layer 140 are attracted to or repelled by the voltage on individual conductive areas 1070. Where light-colored particles are driven toward the transparent electrode 122, a viewer will see a lighter color. Where dark-colored particles are driven toward the transparent electrode 122, a viewer will see a darker color. See FIG. 1A for additional details of the particles and movement of the particles by an electric field. If the conductive areas 1070 are individually addressable, the electro-optic device 1000 can display text or pixelated images. Such electro-optic devices 1000 may be the basis for electro-optic displays on eReaders, mobile phones, watches, ePosters, etc.

Having thus described at least one illustrative embodiment of the invention, various alterations, modifications and improvements will readily occur to those skilled in the art. Such alterations, modifications, and improvements are intended to be part of this disclosure, and are intended to be within the spirit and the scope of the present invention. Accordingly, the foregoing description is by way of example only and is not intended to be limiting. The present invention is limited only as defined in the following claims and the equivalents thereto.

1. A flowable mixture comprising:
an encapsulated electrophoretic medium including an internal phase comprising a hydrocarbon liquid and suspended pigment particles; and
a polymeric binder comprising less than 5% (by weight) of solvent, wherein the viscosity of the flowable mixture is between 500 Centipoise and 10,000 Centipoise.

2. The flowable mixture of claim 1, wherein the electrophoretic medium is encapsulated in a capsule having walls comprising collagen.

3. The flowable mixture of claim 2, wherein the average capsule diameter is less than 50 micrometers.

4. The flowable mixture of claim 1, wherein the encapsulated electrophoretic medium is freeze dried.

5. The flowable mixture of claim 1, wherein the polymeric binder comprises less than 1% (by weight) of solvent.

6. The flowable mixture of claim 5, wherein the mixture is 100% solids.

7. The flowable mixture of claim 1, wherein the polymeric binder comprises an acrylate or a polyurethane.

8. The flowable mixture of claim 1, wherein the polymeric binder is radiation-curable.

9. The flowable mixture of claim 1, wherein the polymeric binder comprises cross-linkers.

10. The flowable mixture of claim 1, wherein a refractive index of the polymeric binder matches a refractive index of capsule walls encapsulating the electrophoretic medium.

11. The flowable mixture of claim 1, wherein the refractive index of the polymeric binder is between 1.50 and 1.60 at 550 nm.

12. An electro-optic device comprising:
a first substrate having a first conductive layer thereon;
a second substrate having a second conductive layer thereon; and
the flowable mixture of claim 1, interposed between the first conductive layer and the second conductive layer.

13. The electro-optic device of claim 12, wherein the first substrate and the first conductive layer are transparent or the second substrate and the second conductive layer are transparent.

14. The electro-optic device of claim 12, wherein the first and second substrates and the first and second conductive layers are transparent.

15. The electro-optic device of claim 12, wherein the first conductive layer or the second conductive layer comprises indium tin oxide.

16. The electro-optic device of claim 12, wherein the first or second conductive layer comprises a contact region.

17. The electro-optic device of claim 12, wherein the device does not include an adhesive layer interposed between the first conductive layer and the flowable mixture of claim 1, or between the second conductive layer and the flowable mixture of claim 1.

18. A method for making an electro-optic device, comprising:
coating a first substrate having a first conductive layer thereon with a flowable mixture comprising an encapsulated electrophoretic medium including an internal phase comprising a hydrocarbon liquid and suspended pigment particles and a polymeric binder comprising less than 5% (by weight) of solvent, wherein the viscosity of the flowable mixture is between 500 Centipoise and 10,000 Centipoise, thereby creating a stack;
applying to the stack a second substrate having a second conductive layer thereon, wherein no adhesive layer is interposed between the first conductive layer and the flowable mixture or between the second conductive layer and the flowable mixture.

19. The method of claim 18, wherein the polymeric binder is radiation-curable and the method further comprises curing the polymeric binder.

20. The method of claim 18, further comprising forming a contact region on the first or the second conductive layer.

21. The method of claim 20, wherein the contact region is formed on the first conductive layer and the method further comprises masking an area of the first substrate before coating the first conductive layer with the flowable mixture.
